(19) United States
(12) Patent Application Publication
(10) Pub. No.: US 2026/0252983 A1
(43) Pub. Date: Aug. 27, 2026

(54) SYSTEM AND METHOD FOR SCHEDULING FOCUS-TIME SLOTS FOR DIGITAL SKILLS DURING WORKFORCE MANAGEMENT (WFM) SCHEDULING

(71) Applicant: NICE LTD., Ra'anana (IL)

(72) Inventors: Disha AGRAWAL, Pune (IN); Amol SALUNKHE, Mumbai (IN); Abhishek UNHALE, Pune (IN)

(21) Appl. No.: 19/064,764

(22) Filed: Feb. 27, 2025

(51) Int. Cl. G06Q 10/0631; G06F 9/54; H04L 67/55

(52) U.S. Cl. CPC G06Q 10/063112; G06F 9/54; H04L 67/55

(57) ABSTRACT

A computerized-method for determining critical-time-slots and scheduling focus-activity therefore during WFM scheduling. The computerized-method includes while generating a schedule: a) for each time-slot: (i) retrieving forecast-data of forecasted interaction volumes of traditional-interactions and forecasted active-counts for digital-interactions; (ii) retrieving historic-data of adherence and calculating predicted out-of-adherence percentage for each agent; (iii) determining the time-slot as one of: traditional-interactions-time; and digital-interactions-time, based on the forecasted interaction volumes of traditional-interactions and the forecasted active-counts for digital-interactions; b) for each agent, for each time-slot that has been determined as traditional-interactions-time determining critical-traditional-interactions-time and for each time-slot that has been determined as digital-interactions-time, determining critical-digital-interactions-time based on the retrieved forecasted-data, AHT and maximum staffing; and c) for each agent having in-adherence above adherence-threshold, scheduling focus-activity for digital skills as the activity-type during time-slots that were determined as critical-digital-interactions-time, and focus-activity for traditional skills as the activity-type during the time-slots that were determined as critical-traditional-interactions-time.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of scheduling focus-time slots for digital skills during Workforce Management (WFM) scheduling.

### BACKGROUND

In current contact centers, certain time intervals require higher staffing levels due to increased customer interaction. However, when agents fail to adhere to their schedules during these critical times, it results in diminished customer satisfaction and reduced efficiency within the contact center. One of the primary challenges with current systems is that agents frequently fall out of adherence, even when they are scheduled to manage interactions during peak times. This non-adherence during high-demand intervals significantly impacts the quality of customer service and operational effectiveness.

Additionally, agents are often permitted to be out of adherence even when their schedules indicate “open” activities, which are crucial for handling unplanned customer interactions and other essential tasks. This flexibility further exacerbates the problem of non-adherence during critical periods. Supervisors are thus required to continuously monitor agents, especially during these crucial time-intervals, to maintain high adherence levels and ensure that customer inquiries are addressed promptly. This constant oversight is both labor-intensive and challenging, putting additional strain on supervisory staff.

Moreover, the existing system lacks the capability to highlight time-intervals with anticipated high volumes of traditional calls or periods with significant backlogs of digital interactions. This deficiency makes it difficult to prepare adequately and allocate resources efficiently to meet the demand.

Finally, the responsibility of manually updating schedules for specific activities falls on managers, which is not only time-consuming but also prone to human error. This manual intervention is inefficient and highlights the need for a more automated and dynamic scheduling system.

Therefore, there is a need for a technical solution to automatically determine and schedule focus intervals during critical times of the day for each agent, ensuring high adherence and an enhanced customer experience. A focus interval, e.g., focus-activity, is defined as a period during the day when an agent's availability is crucial and cannot be compromised.

There is a need for a technical solution for scheduling focus-time slots for digital skills during Workforce Management (WFM) scheduling.

### SUMMARY

There is thus provided, in accordance with some embodiments of the present disclosure, a computerized-method for determining critical-time-slots and scheduling focus-activity therefore during Workforce Management (WFM) scheduling.

Furthermore, in accordance with some embodiments of the present disclosure, the computerized-method may include while generating a schedule for agents in a database of agents for a period of time via a User Interface (UI) that is associated to a WFM system: (i) retrieving forecast data of forecasted interaction volumes of traditional-interactions and forecasted active counts for digital-interactions for each time-slot in the period of time; (ii) retrieving historic-data of adherence and calculating predicted out-of-adherence percentage based on in-adherence Key Performance Indicator (KPI) for each agent; (iii) for each time-slot determining the time-slot as one of: traditional-interactions-time; and digital-interactions-time, based on the forecasted interaction volumes of traditional-interactions and the forecasted active counts for digital-interactions; (iv) for each agent, for each time-slot that has been determined as traditional-interactions-time determining critical-traditional-interactions-time and for each time-slot that has been determined as digital-interactions-time, determining critical-digital-interactions-time based on the retrieved forecasted data, Average Handling Time (AHT) and maximum staffing; and (v) for each agent having in-adherence above adherence-threshold, scheduling focus-activity for digital skills as the activity-type during time-slots that have been determined as critical-digital-interactions-time, and focus-activity for traditional skills as the activity-type during the time-slots that were determined as critical-traditional-interactions-time.

Furthermore, in accordance with some embodiments of the present disclosure, the computerized-method may further include scheduling activity-type that is not focus-activity during time-slots which were not determined as one of critical-traditional-interactions-time and critical-digital-interactions-time and scheduling activity-type that is not focus-activity during time-slots that the agent is not having in-adherence above adherence-threshold.

Furthermore, in accordance with some embodiments of the present disclosure, the time-slot-may be determined as traditional-interactions-time when the forecasted traditional-interactions volume is higher than the forecasted digital-interactions volume and the time-slot may be determined as digital-interactions-time when the forecasted digital-interactions volume is higher than the forecasted traditional-interactions volume.

Furthermore, in accordance with some embodiments of the present disclosure, the time-slot may be determined as critical-traditional-interactions-time, when a sum of maximum staffing, AHT and the forecasted interaction volumes of traditional-interactions during the time-slot is higher than a predefined threshold and the time-slot may be determined as critical-digital-interactions-time, when a sum of maximum staffing, AHT and the forecasted interaction volumes of digital-interactions during the time-slot is higher than the predefined threshold.

Furthermore, in accordance with some embodiments of the present disclosure, the calculating of the predicted out-of-adherence percentage for each agent in the database of agents may be calculated according to formula I:

$$predicted out - of - adherence percentage = 100 - ( Sum ( in - adherence KPI ) / Sum ( time duration of each time - slot in the time - slots determined as critical - traditional - interactions - time and as critical - digital - interactions - time ) * 100 , \qquad ( I )$$

whereby,
the sum (adherence KPI) is the sum of the adherence KPI of the agent in all adherence-time-slots, and
the sum of time duration of each time-interval in the adherence-time-slots is the duration of all time-intervals in minutes in the adherence-time-slots.

Furthermore, in accordance with some embodiments of the present disclosure, the computerized-method may further include publishing the schedule for each agent by pushing notifications via an application that is running on a computerized device of the agent.

Furthermore, in accordance with some embodiments of the present disclosure, the activity-type of focus-activity may indicate a time-slot that the agent has to be in-adherence.

Furthermore, in accordance with some embodiments of the present disclosure, the scheduling may be operated by a schedule manager Microservice (MS).

Furthermore, in accordance with some embodiments of the present disclosure, the retrieving of the forecast data and historic-data of adherence for each agent may be operated by using Representational State Transfer (REST) Application Programming Interfaces (API) s.

Furthermore, in accordance with some embodiments of the present disclosure, the traditional-interactions may be at least one of: voice-interactions and chat-interactions and the digital-interactions may be at least one of: social media chat messenger, email and messaging application.

Furthermore, in accordance with some embodiments of the present disclosure, the generating of the schedule may be operated by a user-click on an icon in the UI that is associated to the WFM system. The schedule is displayed via the UI that is associated to the WFM system.

Furthermore, in accordance with some embodiments of the present disclosure, the computerized-method may further include configuring the WFM system to operate the generated schedule and to send an Automatic Call Distribution (ACD) application an update as to the activity-type for each agent when the activity-type has been scheduled as one of: focus-activity for digital skills and focus-activity for traditional skills. The computerized-method may further include configuring the ACD application to automatically change a state of each agent that the activity-type has been scheduled as focus-activity for digital skills to ‘available’ during the time-slot, and to route digital interactions to agents with focus-activity for digital skills and traditional interactions to agents having focus-activity for traditional skills.

Furthermore, in accordance with some embodiments of the present disclosure, the computerized-method may further include configuring the WFM system to restrict any change of activity-type for agents during the time-slot that the activity-type is focus-activity for digital skills and during the time-slot that the activity-type is focus-activity for traditional skills.

There is further provided, in accordance with some embodiments of the present disclosure, a computerized-system for determining critical-time-slots and scheduling focus-activity therefore during Workforce Management (WFM) scheduling.

Furthermore, in accordance with some embodiments of the present disclosure, the computerized-system may include a database of agents, a User Interface (UI) that is associated to a WFM system, and one or more processors. While generating a schedule for agents in the database of agents for a period of time via the User Interface (UI) that is associated to the WFM system: (i) retrieving forecast data of forecasted interaction volumes of traditional-interactions and forecasted active counts for digital-interactions for each time-slot in the period of time; (ii) retrieving historic-data of adherence and calculating predicted out-of-adherence percentage based on in-adherence Key Performance Indicator (KPI) for each agent; (iii) for each time-slot determining the time-slot as one of: traditional-interactions-time; and digital-interactions-time, based on the forecasted interaction volumes of traditional-interactions and the forecasted active counts for digital-interactions; (iv) for each agent, for each time-slot that has been determined as traditional-interactions-time determining critical-traditional-interactions-time and for each time-slot that has been determined as digital-interactions-time, determining critical-digital-interactions-time based on the retrieved forecasted data, Average Handling Time (AHT) and maximum staffing; and (v) for each agent having in-adherence above adherence-threshold, scheduling focus-activity for digital skills as the activity-type during time-slots that have been determined as critical-digital-interactions-time, and focus-activity for traditional skills as the activity-type during the time-slots that were determined as critical-traditional-interactions-time.

### BRIEF DESCRIPTION OF THE DRAWINGS

FIGS. 1A-1B schematically illustrate a high-level diagram of a system for scheduling focus-time slots for digital skills during Workforce Management (WFM) scheduling, in accordance with some embodiments of the present disclosure;

FIGS. 2A-2B are a high-level workflow of a computerized-method for scheduling focus-time slots for digital skills during WFM scheduling, in accordance with some embodiments of the present disclosure;

FIG. 3 schematically illustrates a high-level diagram of a system for scheduling focus-time slots for digital skills during WFM scheduling in a cloud computing environment, in accordance with some embodiments of the present disclosure;

FIG. 4 is a high-level workflow of a focus engine, in accordance with some embodiments of the present disclosure;

FIG. 5 is a high-level workflow of a focus engine, in accordance with some embodiments of the present disclosure;

FIG. 6 schematically illustrates a high-level diagram of a system for scheduling focus-time slots for digital skills during WFM scheduling in a cloud computing environment, in accordance with some embodiments of the present disclosure;

FIG. 7 schematically illustrates a high-level diagram of components that generate forecast and fetch the forecast and KPI data, in accordance with some embodiments of the present disclosure;

FIG. 8 schematically illustrates a high-level diagram of components to automate schedule change and fetch on a user request, in accordance with some embodiments of the present disclosure;

FIG. 9 is a high-level workflow of agent state change based on focus time-slot, in accordance with some embodiments of the present disclosure;

FIG. 10 is a screenshot of a User Interface (UI) that is associated to a WFM system with agent state change, in accordance with some embodiments of the present disclosure;

FIG. 11 is a screenshot of a UI that is associated to a WFM system of agent current schedule including focus time-slot, in accordance with some embodiments of the present disclosure;

FIG. 12 is a simulation of an output of a computerized-method for scheduling focus-time slots for digital skills during WFM scheduling, in accordance with some embodiments of the present disclosure; and

FIG. 13 is a screenshot of a UI that is associated to a WFM system for a manager to view schedule with focus time-slot, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Multiple processes are involved in workforce management of a contact center, such as forecasting, staffing, scheduling, adherence, and intraday management. Forecasting and staffing are the first step to estimate the volume of expected interaction and predict the agent required to handle the same. The next step is scheduling, which involves planning for agent's time to handle the call interaction. Last process is adherence and intraday management to keep track of agent's activity and deviation in the forecast.

Adherence is an agent specific Key Performance Indicators (KPI). It indicates deviation of the agent from the scheduled activity. If the agent is not performing as per the schedule, it is considered as out of adherence otherwise it is an in-adherence situation. This agent adherence metric is used to track the agent performance and efficiency of the contact center during the peak times of interactions during a scheduled shift.

The process of forecasting is performed to predict the call volumes and average handle time in each time-interval, e.g., time-slot for the future dates when scheduling schedules in a period for the agent. It is used to determine the future work required. It is forecasted for every 15-min interval and divides the workforce. Further using the forecasted volume, the staffing is done to predict the number of head count required for each interval. The process of scheduling is performed to determine which agent will be scheduled at every time-interval to perform a certain activity.

Currently, the forecasting and scheduling is determined equally for all types of interactions, ignoring the type of interaction which may be traditional-interaction or digital-interaction depending on skills and agent's skills proficiency.

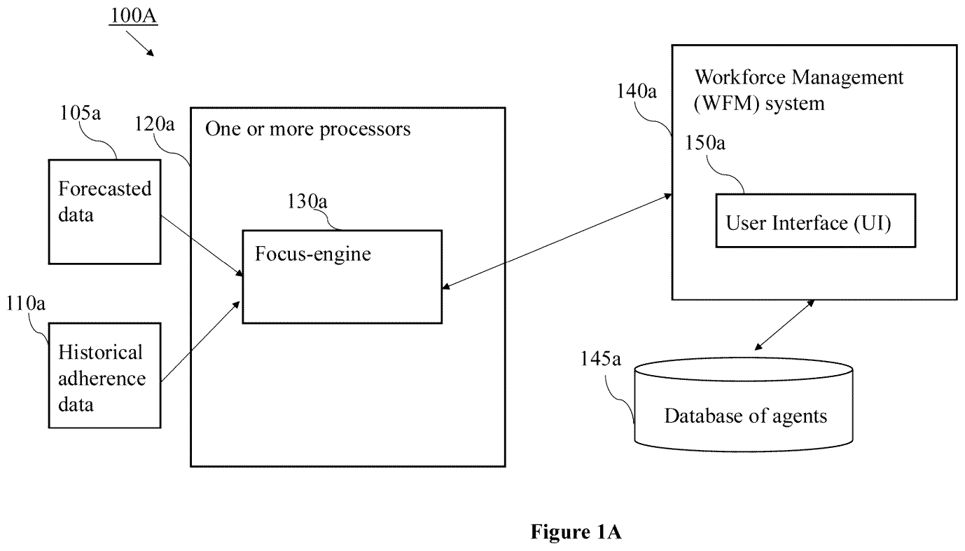

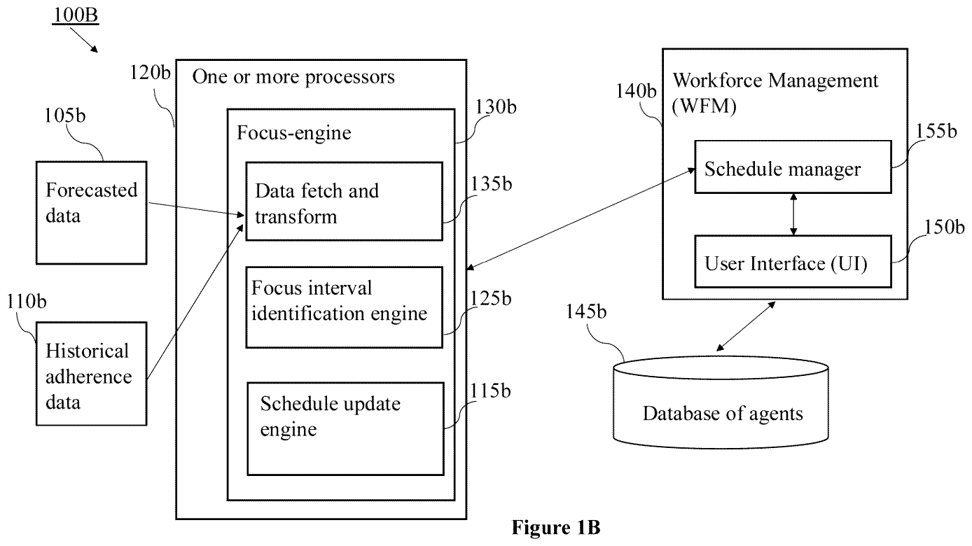

FIG. 1A schematically illustrates a high-level diagram of a system 100A for scheduling focus-time slots for digital skills during Workforce Management (WFM) scheduling, in accordance with some embodiments of the present disclosure.

According to some embodiments of the present disclosure, in a system, such as system 100A while generating a schedule for agents in a database of agents 145a for a period via a User Interface (UI) 150a that is associated to a WFM system 140a configuring a schedule manager Microservice (MS) component (not shown) in the WFM system 140a to operate a focus-engine 130a by one or more processors 120a.

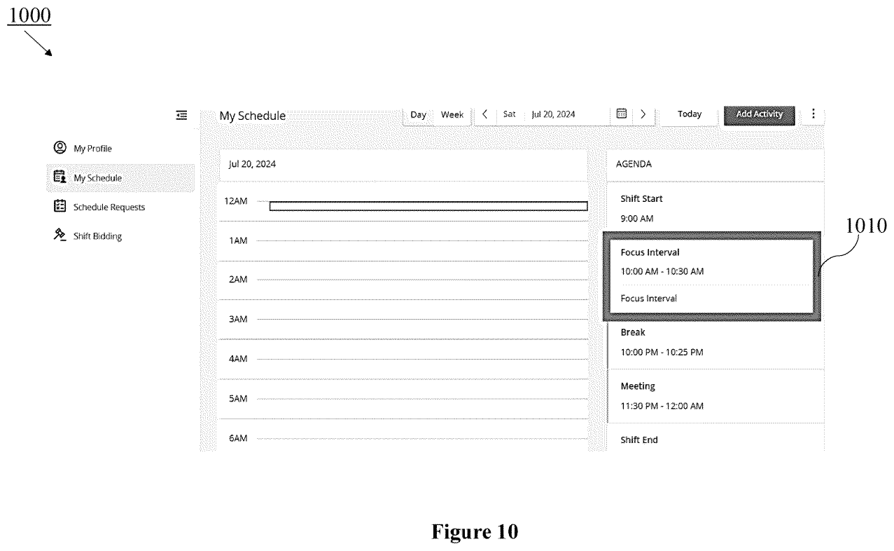

According to some embodiments of the present disclosure, the generating of the schedule may be operated by a user-click on an icon or a button in the UI 150a that is associated to the WFM system 140a and the schedule may be displayed via the UI 150a that is associated to the WFM system 140a. For example, as shown in FIG. 10.

According to some embodiments of the present disclosure, the focus-engine 130a may retrieve forecast data 105a of forecasted interaction volumes of traditional-interactions and forecasted active counts for digital-interactions for each time-slot in the period. Active counts is a parameter that indicates the number of digital interactions that await in a queue.

According to some embodiments of the present disclosure, for each time-slot of the schedule in the period of time, determining the time-slot as one of: traditional-interactions-time and digital-interactions-time, based on the forecasted interaction volumes of traditional-interactions and the forecasted active counts for digital-interactions. The time-slot may be determined as traditional-interactions-time when the forecasted traditional-interactions volume is higher than the forecasted digital-interactions volume and the time-slot may be determined as digital-interactions-time when the forecasted digital-interactions volume is higher than the forecasted traditional-interactions volume.

According to some embodiments of the present disclosure, the historic-data of adherence may be retrieved and the predicted out-of-adherence percentage may be calculated based on in-adherence Key Performance Indicator (KPI) for each agent.

According to some embodiments of the present disclosure, for each agent, for each time-slot that has been determined as traditional-interactions-time, critical-traditional-interactions-time may be determined and for each time-slot that has been determined as digital-interactions-time, critical-digital-interactions-time may be determined based on the retrieved forecasted data, Average Handling Time (AHT) and maximum staffing.

According to some embodiments of the present disclosure, digital interactions are asynchronous which means they do not require immediate response. Also, the resolution may be across multiple time-intervals or days. In such a case, volume is not efficient metric to be tracked. Instead, different metric called active/backlog count is used. It indicates the number of digital interactions that are left unresolved/open since pervious interval till current time-slot. So, if the backlog of open digital interaction is high, the time-slot is eligible to be focus-activity for digital skills.

According to some embodiments of the present disclosure, scheduling focus-activity for digital skills as the activity-type during critical time-slots, that the predicted out-of-adherence percentage for the agent is above a preconfigured adherence-threshold.

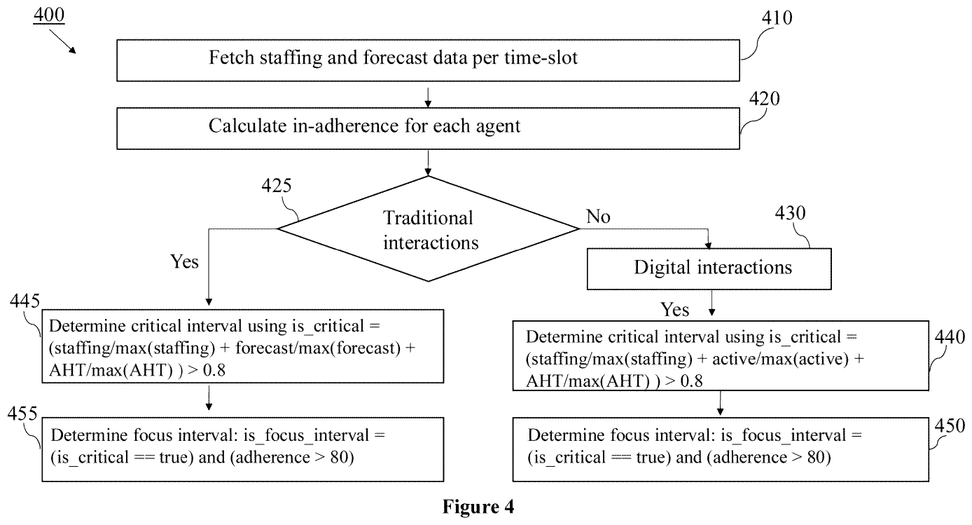

According to some embodiments of the present disclosure, traditional interactions, such as phone calls are synchronous and may require immediate attention and are likely to end in a short duration. They have higher priority over digital skill. If these traditional interactions are routed to agents continuously, it may lead to delay in handling the assigned digital interactions, like chat or email. To avoid indefinite delays of digital interactions, a focus interval, e.g., focus-activity for the same may be scheduled. During this focus interval more digital interactions are expected to be routed. The adherence pattern for both traditional and digital skills may be analyzed. For a time-slot that the predicted out-of-adherence is less than a threshold and the forecasted volume of traditional skills is less than a preconfigured traditional-threshold, such intervals may be considered as focus-activity for a digital skill and same is scheduled. For example, is_critical=(staffing/max (staffing)+forecast/max (forecast)+AHT/max (AHT))>0.8, as shown in element 445 in FIG. 4. Call durations can be used to determine the AHT.

According to some embodiments of the present disclosure, the time-slot may be determined as critical-traditional-interactions-time, when a sum of maximum staffing, AHT and the forecasted interaction volumes of traditional-interactions during the time-slot is higher than a predefined threshold, e.g., 0.8, and the time-slot may be determined as critical-digital-interactions-time, when a sum of maximum staffing, AHT and the forecasted interaction volumes of digital-interactions during the time-slot is higher than the predefined threshold.

According to some embodiments of the present disclosure, focus-activity may be scheduled for digital skills as the activity-type during time-slots that have been determined as critical-digital-interactions-time. Focus-activity may be scheduled for traditional skills as the activity-type during the time-slots that were determined as critical-traditional-interactions-time.

According to some embodiments of the present disclosure, activity-type that is not focus-activity may be scheduled during time-slots which were not determined as one of critical-traditional-interactions-time and critical-digital-interactions-time. Activity-type that is not focus-activity may be scheduled during time-slots that the agent is not having in-adherence above adherence-threshold.

According to some embodiments of the present disclosure, the WFM system has a time-slot wise historical data, received from the ACD systems integrations which stores the following information: Skill, Volume, Duration. For example, 10:00-10:15 Skill=Email Volume=2. 10:15-10:30 Skill=Phone Volume=5. Based on this interval wise data and skill name percentage of out-of-adherence can be calculated for digital and traditional skills separately.

According to some embodiments of the present disclosure, the traditional-interactions may be at least one of: voice-interactions and chat-interactions and the digital-interactions may be at least one of: social media chat messenger, email and messaging application.

According to some embodiments of the present disclosure, the retrieval of the forecast data 105a and historic-data of adherence 110a for each agent may be operated by using Representational State Transfer (REST) Application Programming Interfaces (API) s.

According to some embodiments of the present disclosure, the focus-activity may be scheduled for traditional interactions to avoid scheduling of digital skills, on the same time-slots.

According to some embodiments of the present disclosure, the out-of-adherence percentage for each agent in the database of agents 145a during these critical time-slots may be calculated using historical adherence data by retrieving historic-data of adherence for each agent for the traditional-interactions and the digital-interactions.

According to some embodiments of the present disclosure, the calculating of the out-of-adherence percentage during each identified time-slots for each agent in the database of agents 145a may be performed based on the retrieved historic agent adherence-data according to formula I:

$$predicted out - of - adherence percentage = 100 - ( Sum ( in - adherence KPI ) / Sum ( time duration of each time - slot in the time - slots ) * 100 , \qquad ( I )$$

whereby,
the sum (in-adherence KPI) is the sum of the adherence KPI of the agent in all time-slots that the agent was in-adherence:

According to some embodiments of the present disclosure, the WFM system 140a may be integrated with the ACD application to fetch the actual activities of the agents. The actual activities of the agents may be compared with WFM schedules to generate adherence. Based on these calculations the WFM system 140a has real-time and historical adherence data.

According to some embodiments of the present disclosure, the historic-data of adherence and the predicted out-of-adherence percentage during adherence-time-slots for each agent may be analyzed to schedule an activity-type for each agent in the database of agents 145a for each time-slot in the time-slots in the period. The analysis may include the calculated out-of-adherence percentages of intervals and particular activity.

According to some embodiments of the present disclosure, for each agent, for each time-slot that has been determined as traditional-interactions-time determining critical-traditional-interactions-time and for each time-slot that has been determined as digital-interactions-time, determining critical-digital-interactions-time based on the retrieved forecasted data, Average Handling Time (AHT) and maximum staffing.

According to some embodiments of the present disclosure, each agent having in-adherence above adherence-threshold may be scheduled a focus-activity for digital skills as the activity-type during time-slots that have been determined as critical-digital-interactions-time, and focus-activity for traditional skills as the activity-type during the time-slots that were determined as critical-traditional-interactions-time.

According to some embodiments of the present disclosure, the threshold may be calculated based on the customer's own requirement or KPI. It can also be configured by a manager as an input while initiating the scheduling process via the WFM system 140a.

According to some embodiments of the present disclosure, the focus-activity may indicate a time-slot that the agent has to be in-adherence, which means that the agent has to be available and receive interactions from customers.

According to some embodiments of the present disclosure, activity-type that is not focus-activity may be scheduled during time-slots which were not determined as one of critical-traditional-interactions-time and critical-digital-interactions-time and scheduling activity-type that is not focus-activity during time-slots that the agent is not having in-adherence above adherence-threshold.

According to some embodiments of the present disclosure, the schedule for the agents may be published by pushing notifications to the agents in an application that is running on a computerized-device of each agent. The publishing ensures the schedules generated are not in the draft state and post publish are visible to agent in their working system.

According to some embodiments of the present disclosure, the WFM system 140a may be configured to operate the generated schedule and to send to an Automatic Call Distribution (ACD) application an update as the activity-type for each agent when the activity-type has been scheduled as focus-activity for digital skills or as focus-activity for traditional skills.

According to some embodiments of the present disclosure, the ACD application may be configured to automatically change a state of each agent that the activity-type has been scheduled as focus-activity for digital skills or focus-activity for traditional skills to ‘available’ during the time-slot, and to route digital interactions to agents with focus-activity for digital skills and traditional interactions to agents having focus-activity for traditional skills.

According to some embodiments of the present disclosure, the WFM system 140a may be configured to restrict changes of activity-type for agents during the time-slot that the activity-type is focus-activity.

According to some embodiments of the present disclosure, the change of activity-type which may be restricted by the WFM system 140a may be operated manually or via another application such as a coaching application.

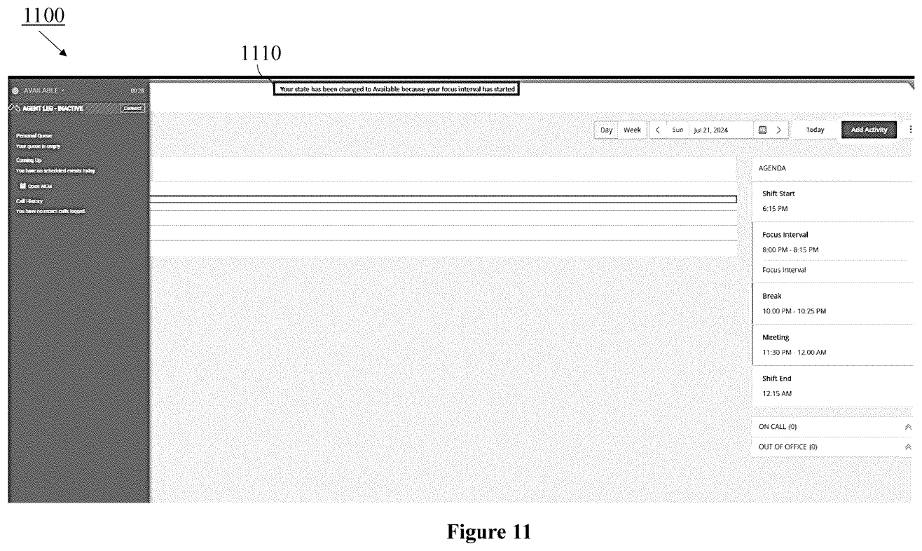

According to some embodiments of the present disclosure, a push notification may be automatically sent for each agent when the time-slot that the activity-type is focus-activity starts and when the time-slot that the activity-type is focus-activity ends. The push notification may be presented via the UI 150a. For example, as shown in FIG. 11.

According to some embodiments of the present disclosure, for the time-duration during which the focus-activity is scheduled, the WFM system 140a may be configured to suspend change or update of the schedule to another activity, such as break or out of office and the coaching system may be configured to suspend scheduling of training for the agent during the scheduled focus-activity for digital skills and during focus-activity for traditional skills.

According to some embodiments of the present disclosure, in case of change in forecast or generation of a new forecast in the WFM system 140a, the focus-activity that has been scheduled may be re-evaluated and the updated schedules may be re-published.

According to some embodiments of the present disclosure, the generated schedule may be displayed to the agents via an application that is running on a computerized-device. The application may be configured to restrict changes in the schedule or apply a partial day time-off during this time that the agent is scheduled focus-activity for digital skills and during focus-activity for traditional skills.

According to some embodiments of the present disclosure, the routing algorithms in the ACD application may be configured to handle focus-activity for digital skills in the queue of interactions as follows. Selecting and routing to a random agent in a list of agents which are in an ‘available’ state and agents having focus-activity for digital skills in current time-slot. The parameter of ‘available’ state refers to the state where agents are ready to accept calls or digital interactions, and these interactions can be directed towards them. Agents may not necessarily be in ‘available’ before the focus-activity state begins, hence they are being notified via the UI and their state is changed to ‘available’. For example, as shown in FIG. 11.

According to some embodiments of the present disclosure, the routing algorithms in the ACD application may be configured to handle focus-activity for traditional skills in the queue of interactions as follows. In the case of traditional interactions, calls are directed to agents during focus-activity for traditional interactions, whereas multiple digital interactions, may be directed to agents simultaneously to reduce the digital interactions queue, due to the difference in handling compared to traditional interactions which requires immediate attention. Traditional interactions require an immediate response as compared to digital interactions. Digital interactions can be handled by the agents after the end of traditional interaction.

According to some embodiments of the present disclosure, scheduling of focus time slots may be initiated along with WFM scheduling process. For example, the schedules for 10 Oct. 2024 can be generated one week prior on e.g., 1 Oct. 2024 and the ACD routing may be operated in real time i.e., on 10 Oct. 2024.

FIG. 1B schematically illustrates a high-level diagram of a system 100B for scheduling focus-time slots for digital skills during Workforce Management (WFM) scheduling, in accordance with some embodiments of the present disclosure.

According to some embodiments of the present disclosure, system 100B may include similar components as system 100A in FIG. 1A including a focus-engine 130b for focus interval management within a WFM system 140b. Each component in system 100B may be hosted on a cloud-based computing environment such as Amazon Web Services (AWS).

According to some embodiments of the present disclosure, the WFM database, e.g., cloud hosted AWS Relational Database Service (RDS), may store forecast data 105b and historical adherence data 110b. The forecast data 105b may include details, such as skill name, interval, volume, and required staffing. For example, the data structure for each input set may be:

{ ″Skill Name“ : ″Voice″,
“Interval″: ″2024-01-01T05:00:00“ ″Volume″: 300,
“Req. Staffing″: 20.00}

According to some embodiments of the present disclosure, the historical adherence data 110b may include information about individual agents' adherence percentages at specific time-intervals. For example, the data structure may be:

{″Agent ″: “Tim Cook″,
“Interval″: ″2024-01-01T05:00:00″
,″In Adherence″: 60%}

According to some embodiments of the present disclosure, the forecasted data 105b may be extracted from the WFM database and processed by a forecasted-data component. Simultaneously, historical adherence data 110b may be fetched and processed by a historical-adherence-data component.

According to some embodiments of the present disclosure, both forecasted data 105b and historical adherence data 110b may be passed to a data fetch and transform component 135b, which may consolidate and transform the data into a format suitable for further analysis. The component may be logical components written in a coding language like Java®.

According to some embodiments of the present disclosure, the adherence rate may be calculated for each agent. The following formula may be used for the transformation: adherence_rate=Sum (in-Adherence time for interval)/Sum (Scheduled time for interval). The predicted out-of-adherence percentage may be the adherence_rate multiplied by 100 and subtracted from 100.

According to some embodiments of the present disclosure, the transformed data may be fed into the focus-engine 130b,” which analyzes the data to identify specific focus intervals that require attention. Following is the output data structure of the focus-engine 130b:

[{ ″Shift“ :[
″Agent Id″: “Tim Cook“,
“Interval″: “2024-01-01T05:00:00″,
“Activity Code”: “Open” ]}]

According to some embodiments of the present disclosure, once the focus intervals are identified, by the focus-interval identification engine 125b, this information is sent to a schedule update engine 115b which updates the schedules accordingly. The focus-engine 130b may trigger the schedule update process. The updated schedules may include the identified focus intervals, and then managed, and stored in the database of the WFM system.

According to some embodiments of the present disclosure, the updated schedules may be outputted, to the schedule manager 155b, ensuring that the schedules reflect the adjustments based on both forecasted needs and historical adherence performance. Thus, optimizing staffing and adherence management in the WFM system 140b.

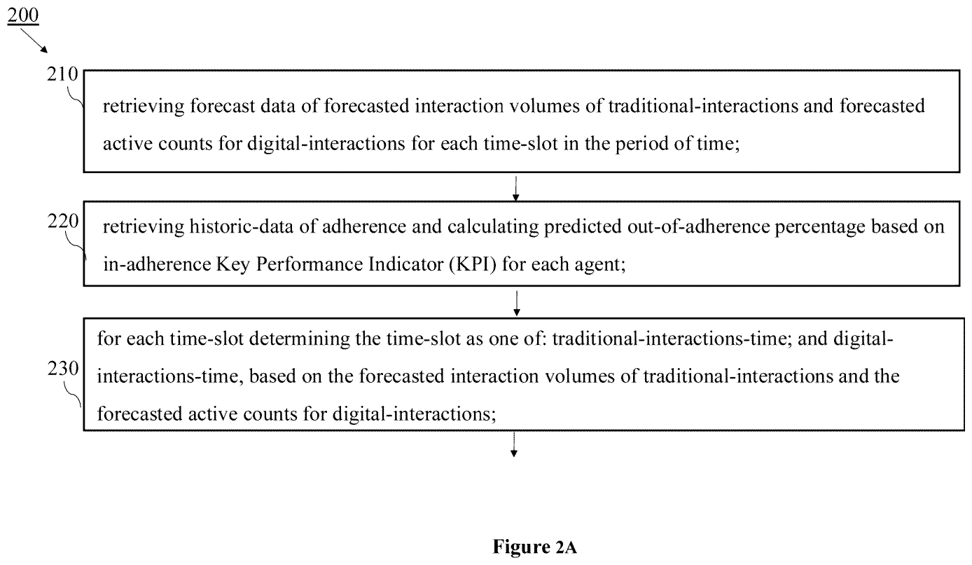

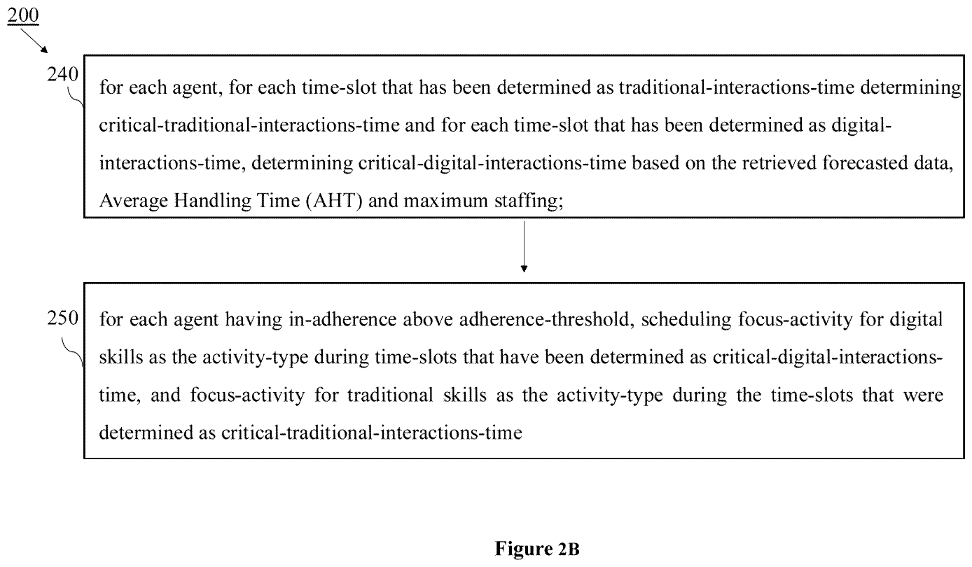

FIGS. 2A-2B are a high-level workflow of a computerized-method for scheduling focus-time slots for digital skills during Workforce Management (WFM) scheduling, in accordance with some embodiments of the present disclosure.

According to some embodiments of the present disclosure, while generating a schedule for agents in a database of agents for a period via a User Interface (UI) that is associated to a WFM system operating operations 210-250.

According to some embodiments of the present disclosure, operation 210 comprising retrieving forecast data of forecasted interaction volumes of traditional-interactions and forecasted active counts for digital-interactions for each time-slot in the period of time.

According to some embodiments of the present disclosure, operation 220 comprising retrieving historic-data of adherence and calculating predicted out-of-adherence percentage based on in-adherence Key Performance Indicator (KPI) for each agent.

According to some embodiments of the present disclosure, operation 230 comprising for each time-slot determining the time-slot as one of: traditional-interactions-time; and digital-interactions-time, based on the forecasted interaction volumes of traditional-interactions and the forecasted active counts for digital-interactions.

According to some embodiments of the present disclosure, operation 240 comprising for each agent, for each time-slot that has been determined as traditional-interactions-time determining critical-traditional-interactions-time and for each time-slot that has been determined as digital-interactions-time, determining critical-digital-interactions-time based on the retrieved forecasted data, Average Handling Time (AHT) and maximum staffing.

According to some embodiments of the present disclosure, operation 250 comprising for each agent having in-adherence above adherence-threshold, scheduling focus-activity for digital skills as the activity-type during time-slots that have been determined as critical-digital-interactions-time, and focus-activity for traditional skills as the activity-type during the time-slots that were determined as critical-traditional-interactions-time.

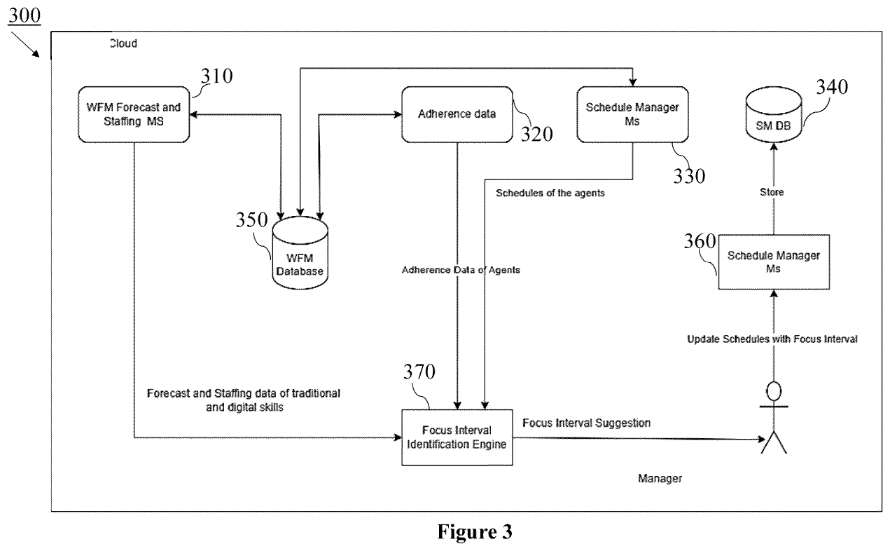

FIG. 3 schematically illustrates a high-level diagram of a system 300 for scheduling focus-time slots for digital skills during Workforce Management (WFM) scheduling in a cloud computing environment, in accordance with some embodiments of the present disclosure.

According to some embodiments of the present disclosure, the components of a system, such as system 100A in FIG. 1A and such as system 100B in FIG. 1B may be deployed in a cloud-based computing environment with restricted access rules. An ACD channel concurrency engine depends on input data received from different sources, such WFM system, other contact center applications and ACD microservices and components which are deployed as containers. For example, AWS Elastic Container Service (ECS) containers. AWS Relational Database Service (RDS) may be used as data storage.

According to some embodiments of the present disclosure, in case a user, such as a manager would like to understand the critical schedule interval post scheduling, the user may complete the staffing and scheduling process and then may initiate the focus interval determination via a UI that is associated to a WFM system. The determination of focus-activity for digital skills and focus-activity for traditional skills may be operated during scheduling of the agents.

According to some embodiments of the present disclosure, upon user click on the UI, such as UI 150b in FIG. 1A the Schedule Manager (SM) MS 360, such as schedule manager 155b in FIG. 1B may store the schedule with focus-activity details in the database 340.

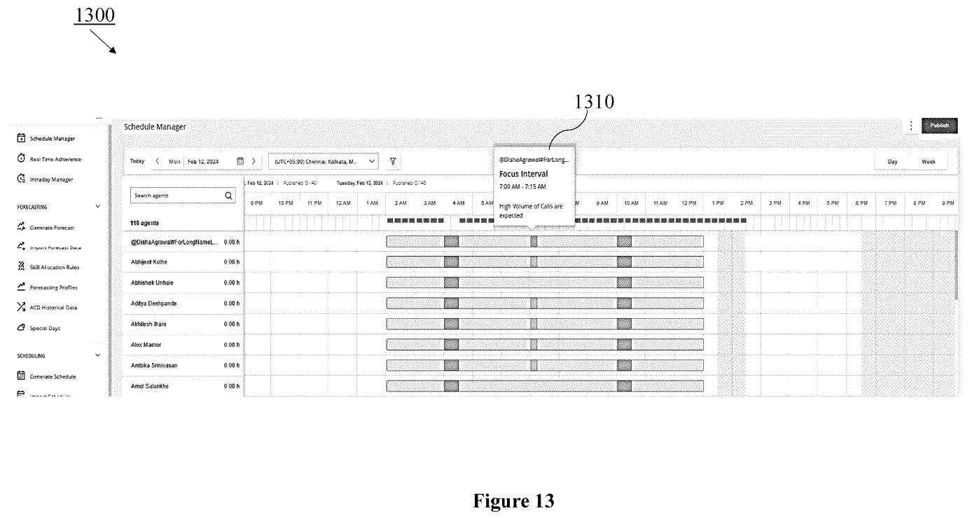

According to some embodiments of the present disclosure, users may request to review focus-activity on the schedules via the UI and monitor agents or system only during those critical durations. For example, as shown in FIG. 13.

According to some embodiments of the present disclosure, the focus interval identification engine 370, such as focus-engine 130a in FIG. 1A and such as focus-engine 130b in FIG. 1B, may fetch the forecasted data, such as forecasted data 105a in FIG. 1A and historical adherence data, such as historical adherence data 110a in FIG. 1A, by using the REST APIs, and gathering the information like time-intervals with high volume and low adherence for each agent.

According to some embodiments of the present disclosure, focus-activity may be scheduled for traditional skill, e.g., traditional-interactions, such as voice and chat messages, by using the interval level forecast data and KPI, such as AHT and volume of interactions and determining the critical interval by using the averaging formula and marking the interval as critical.

According to some embodiments of the present disclosure, focus-activity may be scheduled for digital skill, e.g., digital-interactions such as messaging platform slack, social media chats, email and the like, by using the interval level forecast data and KPI like AHT, active and staffing. A time-slot may be determined as critical-traditional-interactions-time, when a sum of maximum staffing, AHT and the forecasted interaction volumes of traditional-interactions during the time-slot is higher than a predefined threshold and the time-slot may be determined as critical-digital-interactions-time, when a sum of maximum staffing, AHT and the forecasted interaction volumes of digital-interactions during the time-slot is higher than the predefined threshold.

According to some embodiments of the present disclosure, the calculation of agent adherence may be performed by using the adherence data 320 for every time-interval and computing the in-adherence percentage for every agent. This data may be used to determine if the time-interval is a focus interval, e.g., focus-activity for the respective agent.

According to some embodiments of the present disclosure, for every time-interval, if it is determined to be critical for the digital skill, the agent adherence for that time-interval may be checked, if it is below a preconfigured threshold then it may be marked as focus interval.

According to some embodiments of the present disclosure, in a system, such as system 100A in FIG. 1A and such as system 100B in FIG. 1B, the schedule for each agent may be automated for the focus-activity during the critical time-slots, e.g., critical-traditional-interactions-time, critical-digital-interactions-time. The output data, i.e., updated schedules, may be stored in the schedule manager database 340. The results may be displayed to the manager and agent via a UI of a schedule manager webapp associated to the WFM. For example, as shown in FIG. 10 and in FIG. 13.

According to some embodiments of the present disclosure, WFM forecast, and staffing MS 310 may fetch and provide the forecast and staffing data for both traditional and digital skills. This data includes predicted interaction volumes and the required staffing levels to handle those interactions efficiently. The forecast and staffing data may be sent to be stored in the WFM database 350.

According to some embodiments of the present disclosure, adherence data component 320 may process the adherence data of agents, which includes information about how well agents adhere to their schedules in past schedules. The adherence data may be stored in the WFM database 350 and is also provided to the focus interval identification engine 370, such as focus interval identification engine 125b in FIG. 1B.

According to some embodiments of the present disclosure, the schedule manager MS 330 and 360 may manage the schedules of agents, including updates to schedules based on the focus interval suggestions. The schedule manager MS 330 may generate the schedules of agents and update schedules of agents with focus interval suggestions. The updated schedules may be stored in the SM DB 340 and upon user click from a UI may be displayed via the UI, for example as shown in FIG. 13.

According to some embodiments of the present disclosure, the Schedule Manager (SM) database 340 may store the updated schedules that include the focus intervals. The SM database 340 may receive updated schedules from the schedule manager MS 330 with manager's suggestions. For example, once the schedules are generated, they may be displayed to the manager and then the manager may be enabled to update the schedules via the UI, based on other factors, such as time-off requests of agents.

According to some embodiments of the present disclosure, the focus interval identification engine 370 may analyze the adherence data and forecasted interactions volume, staffing and schedules to identify optimal focus intervals for agents. It may ensure that agents are scheduled effectively during high-demand time-intervals. The focus interval identification engine 370 may receive adherence data and forecast and staffing data from the WFM database 350 and provide focus interval suggestions to the schedule manager MS 360.

According to some embodiments of the present disclosure, a user, such as manager in a contact center, may interact with the schedule manager MS 360, such as schedule manager 155b in FIG. 1B, via a UI to view and modify the agent schedules, including the applied focus intervals. The manager may receive updated schedules with suggestions of focus intervals from manager.

FIG. 4 is a high-level workflow of a focus engine 400, in accordance with some embodiments of the present disclosure.

According to some embodiments of the present disclosure, a focus engine 400, such as focus engine 130a in FIG. 1A and such as focus engine 130b in FIG. 1B may be used to optimize agent schedules by identifying critical and focus intervals.

According to some embodiments of the present disclosure, the focus engine 400 may fetch staffing and forecast data per time-slot 410, and then calculate in-adherence for each agent 420. Traditional interactions and digital interactions may be processed differently. For traditional interactions, critical intervals, e.g., critical-traditional-interactions-time, may be determined based on staffing, forecast, and Average Handle Time (AHT) 445. For digital interactions, active status may replace the forecast in the critical interval, e.g., critical-digital-interactions-time calculation. In both cases, focus intervals may be identified if agents are in-adherence e.g., more than 80% of the time during critical intervals.

According to some embodiments of the present disclosure, the schedules may be updated to mark these focus intervals 455 and 450, thus, enhancing adherence and efficiency in workforce management.

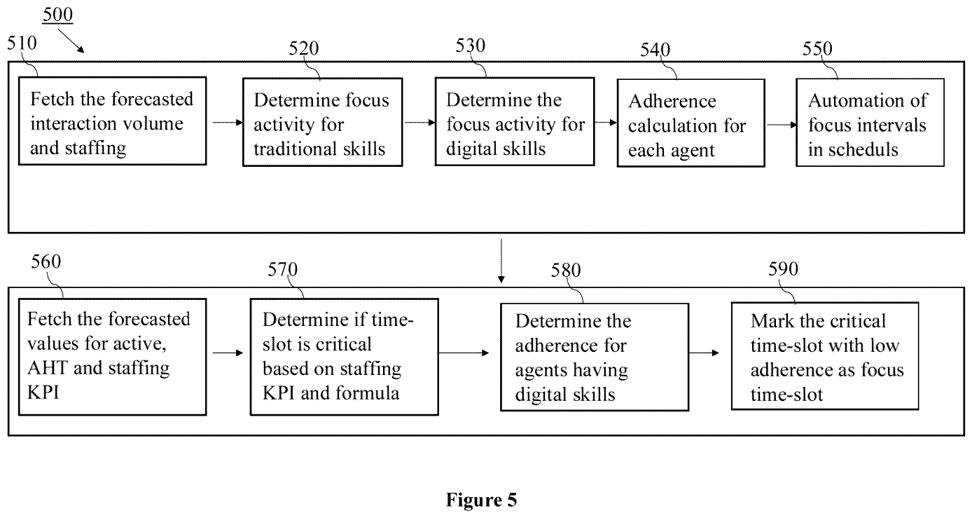

FIG. 5 is a high-level workflow of a focus engine 500, in accordance with some embodiments of the present disclosure.

According to some embodiments of the present disclosure, in a system, such as system 100A in FIG. 1A and such as system 100B in FIG. 1B, fetching the forecasted interaction volume and staffing 510.

According to some embodiments of the present disclosure, determining focus activity for traditional skills 520 and determining the focus activity for digital skills 530.

According to some embodiments of the present disclosure, operating adherence calculation for each agent 540 and automation of focus intervals in schedules 550.

According to some embodiments of the present disclosure, fetching the forecasted values for active, AHT and staffing KPI 560 and determining if the time-slot is critical based on staffing KPI and formula 570. The criticality of a time-slot for digital skill may be calculated based on forecasted values of an active metric such as backlog volume, average handling time, and staffing values.

According to some embodiments of the present disclosure, determining the adherence for agents having digital skills 580 and marking the critical time-slot with low adherence as focus time-slot 590.

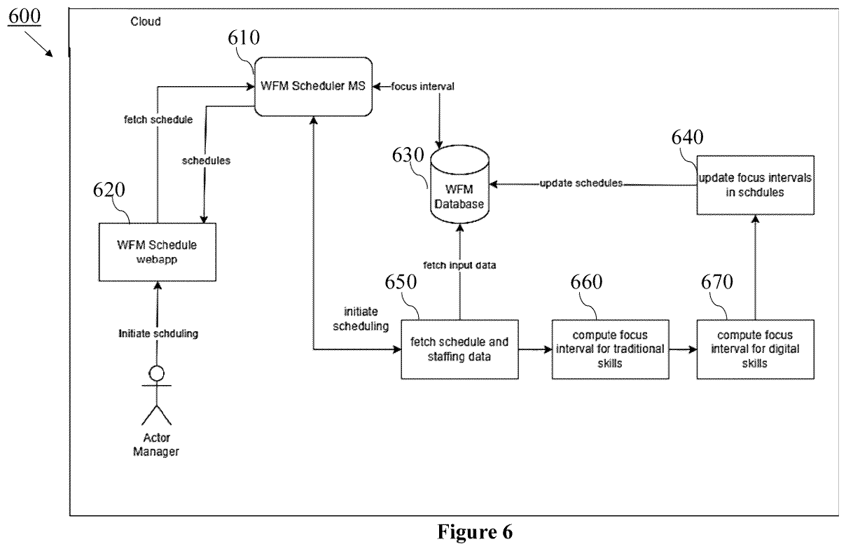

FIG. 6 schematically illustrates a high-level diagram of a system 600 for scheduling focus-time slots for digital skills during WFM scheduling in a cloud computing environment, in accordance with some embodiments of the present disclosure.

According to some embodiments of the present disclosure, in a system, such as system 100A in FIG. 1A and such as system 100B in FIG. 1B, upon user initiation of scheduling process via WFM schedule webapp 620, the WFM schedule webapp 620 may operate a WFM scheduler MS 610. Staffing and forecast data per time-interval may be fetched from the WFM database 630 and in-adherence may be calculated for each agent according to formula II:

in-Adherence duration=sum(in-adherence for interval)/sum(schedule time for interval). (II)

According to some embodiments of the present disclosure, for each interval of the day, fetching schedule and staffing data 650 from the WFM database 630 and computing focus interval for traditional skills 660 and computing focus interval for digital skills 670.

According to some embodiments of the present disclosure, determining if it is critical interval using below a formula for traditional-interactions:

$$is\_critical = ( staffing / max ( staffing ) + forecast / max ( forecast ) + AHT / max ( AHT ) ) > 0.8 ,$$

for each agent's scheduled time-interval, determining if it should be set to be focus-activity, e.g., focus interval:

$$is\_focus \_interval = ( is\_criticial == True ) \&\& ( in - adherence > 80.$$

According to some embodiments of the present disclosure, for each interval of the day, determining if it is critical interval using below a formula for digital-interactions:

$$is\_critical = ( staffing / max ( staffing ) + active / max ( active ) + AHT / max ( AHT ) ) > 0.8$$

for each agent's scheduled time-interval, determining if it should be set to be focus-activity, e.g., focus interval:

$$is\_focus \_interval = ( is\_criticial == True ) \&\& ( in - adherence > 80 ) .$$

According to some embodiments of the present disclosure, updating focus intervals in schedules 640 in the WFM database 630. The schedule may be updated for each time-interval if it is determined as focus interval marking it is as “yes” else “no”.

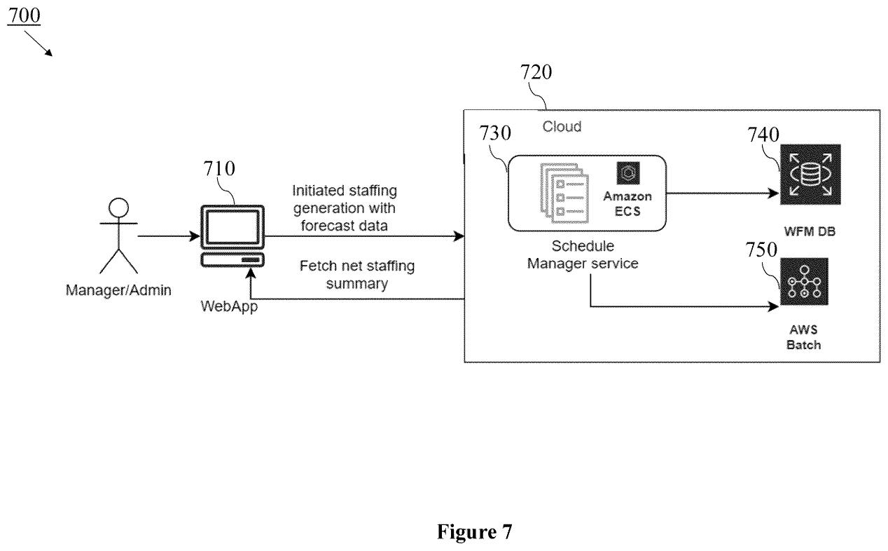

FIG. 7 schematically illustrates a high-level diagram 700 of components that generate forecast and fetch the forecast and KPI data, in accordance with some embodiments of the present disclosure.

According to some embodiments of the present disclosure, upon a user click on a UI that is associated to the WFM system via a webapp 710, a schedule manager service 730, may fetch the forecasted interaction volume and staffing. The schedule manager service 730 may be a component which a is logical monolith microservice that integrates with the WFM database and forecasting module.

According to some embodiments of the present disclosure, the schedule manager service 730 may fetch the forecast, staffing and KPI data, such as interactions volume and AHT for every interval. It also exposes the API for further use by the following components. The final forecast output is stored in the WFM database 740 and fetched from there. The schedule manager service 730 may be implemented for example, in a fully managed container orchestration service provided by Amazon Web Services (AWS)®, such as Amazon Elastic Container Service (ECS).

According to some embodiments of the present disclosure, a focus engine, such as focus engine 130a in FIG. 1A may determine the focus interval, e.g., focus-activity, for digital skills, e.g. digital interactions. The focus engine may use the forecast and KPI like staffing, active contacts and Average Time to Handle (AHT) to determine if the interval is critical or not. Staffing is the number of agents required for the interval. Active contacts is a parameter that indicates the expected backlog interaction in the time-interval and AHT indicates the average time to handle each interaction.

According to some embodiments of the present disclosure, the critical interval may be determined by using the averaging of each KPI as indicated by the below formula. If the staffing and backlog is above a preconfigured threshold it indicates that many agents are required in the time-interval and hence it is critical. The in-adherence data may be used to determine the focus interval.

According to some embodiments of the present disclosure, for each agent, in-adherence may be calculated. In-adherence may indicate the deviation from the expected schedule. The WFM database may store the in-adherence parameter for each schedule and agent.

According to some embodiments of the present disclosure, the algorithm to compute in-adherence parameter for each agent may be as follows: iterating over the agent which has schedule generated, fetching the historical in-adherence data for past period, e.g., past year for the agent and then iterating over the scheduling duration and each interval. Calculating the average in-adherence percentage using the following formula:

$$adherence\_rate = \sum ( In - Adherence Time for Interval ) / \sum ( Scheduled Time for Interval ) .$$

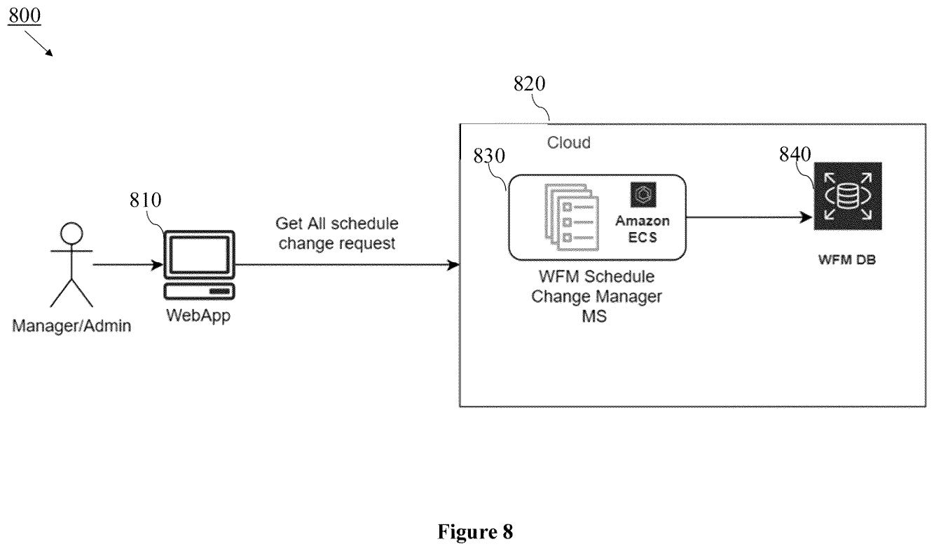

FIG. 8 schematically illustrates a high-level diagram 800 of components to automate schedule change and fetch on a user request, in accordance with some embodiments of the present disclosure.

According to some embodiments of the present disclosure, in a cloud computing environment 820, the WFM schedule change manager MS 830 may identify if the interval in the schedule is focus-activity or not. These schedule changes may be automated in the pre-existing schedule. The updated schedules with focus-interval may be displayed to the manager using the schedule manager webapp 810.

According to some embodiments of the present disclosure, the automation with the focus interval, e.g., focus-activity involves automatically change of the state of the agent to ‘available’. Changing the state to ‘available’ indirectly may impact the ACD routing algorithm to ensure the interactions are routed to the agent. When it is critical-traditional-interactions-time, then traditional interactions may be routed to the agent and when it is critical-digital-interactions-time, then digital interactions may be routed to the agent.

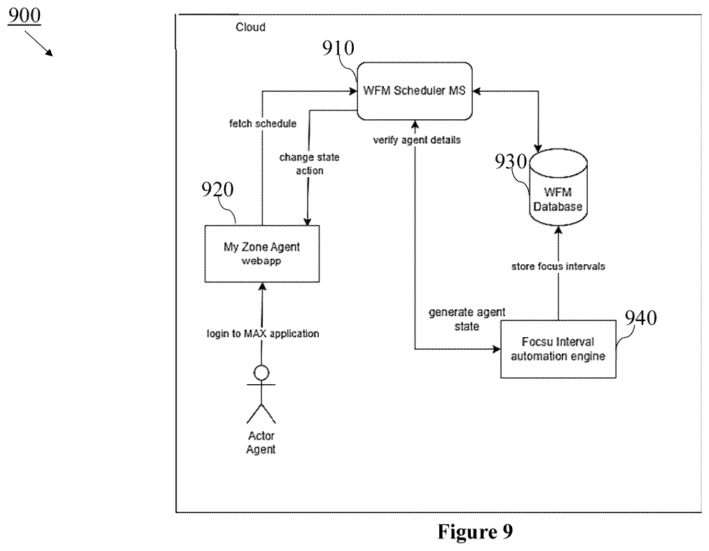

FIG. 9 is a high-level workflow 900 of agent state change based on focus time-slot, in accordance with some embodiments of the present disclosure.

According to some embodiments of the present disclosure, the focus engine may use the determined focus interval, e.g., focus-activity, to determine the behavior of the agent state. As in the focus interval, the agent is expected to receive interaction, it automatically updates the agent state to ‘available’ and indirectly impacts the ACD routing algorithm.

According to some embodiments of the present disclosure, when an agent starts working during the focus interval, e.g., focus-activity, the focus interval and current agent are stored in the WFM database 930. As soon as the focus intervals start, the focus engine may signal the WFM scheduler MS 910 and may fetch the time and agent details along with current agent state. If the focus interval is started, the agent state is changed to ‘available’ or else the current state is retained.

According to some embodiments of the present disclosure, existing ACD routing algorithms may be configured to route the incoming priority interaction to the available agent. Since the agent in focus interval, e.g. focus-activity type may be marked to be ‘available’, the interaction may be routed to them.

FIG. 10 is a screenshot of a User Interface (UI) 1000 that is associated to a WFM system with agent state change, in accordance with some embodiments of the present disclosure.

According to some embodiments of the present disclosure, in a system, such as system 100A in FIG. 1A and such as system 100B in FIG. 1B, after the focus interval, e.g., focus-activity, identification by the focus engine, time slots where high interaction volumes coincide with moderate adherence levels, determined as focus intervals.

According to some embodiments of the present disclosure, the identified focus intervals may be integrated into agent schedules by the schedule manager MS, such as schedule manager MS 155b in FIG. 1B and such as schedule manager MS 360 in FIG. 3. These updated schedules may be stored in the SM database, such as SM database 340 in FIG. 3 and displayed in a section, such as “My Schedule” section of a module, such as the “My Zone” module via the UI 1000.

According to some embodiments of the present disclosure, agents may be notified about the upcoming focus intervals on their schedules. As soon as focus interval, e.g., focus-activity starts, the state of the agent is changed to ‘available’. As the agent state is changed, the routing algorithm that is used in the ACD application may start routing priority interactions to this agent. After the focus interval, e.g., focus-activity is ended, the agent state is set to default depending on the schedule i.e., break, open meeting and the like.

FIG. 11 is a screenshot of a UI 1100 that is associated to a WFM system of agent current schedule including focus time-slot, in accordance with some embodiments of the present disclosure.

According to some embodiments of the present disclosure, in a system, such as system 100A in FIG. 1A and such as system 100B in FIG. 1B, when agents log into the system, they arrive at the “My Schedule” window within the “My Zone” module. This window displays their current schedule, including any focus intervals that have been identified and integrated. The focus intervals are designed to optimize agent performance during periods of high call volume or critical tasks, based on historical adherence data and forecasted demand.

According to some embodiments of the present disclosure, a message, such as “Your state has been changed to available because your focus interval has started” may be displayed via a UI, such as UI 1110 which may be a part of “My Schedule” window, for example, in WFM schedule webapp.

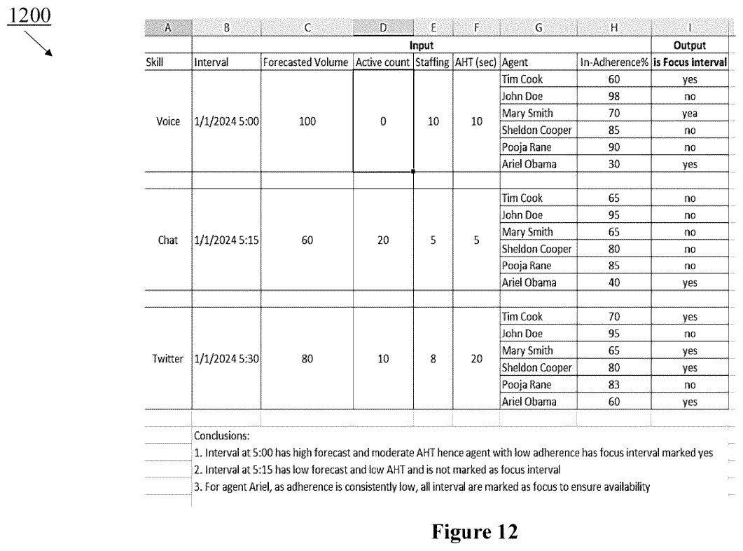

FIG. 12 is a simulation 1200 of an output of a computerized-method for scheduling focus-time slots for digital skills during Workforce Management (WFM) scheduling, in accordance with some embodiments of the present disclosure.

According to some embodiments of the present disclosure, in a system, such as system 100A in FIG. 1A and such as system 100B in FIG. 1B, when a focus interval, focus-activity begins, the system may automatically change the agent's state to ‘available’, to ensure that the agent is ready to handle interactions immediately. Thus, enhancing the efficiency of call distribution by the ACD application. By prioritizing agent availability during critical periods, the system may maintain high service levels and reduce customer wait times.

According to some embodiments of the present disclosure, in the simulated use case, there are three skills: voice, chat and Twitter® for which focus interval, e.g., focus-activity as the activity-type during the adherence-time-slot is to be determined. Out of these skills, voice is traditional, and the others are digital skills. The input section indicates the forecast data generated for an interval for each skill. For example, for voice skill at interval Jan. 1, 2024 5:00, the forecasted interactions volume is 100, staffing is 10 and AHT is 10 seconds. As this is traditional skill, active count is 0. On contrary as Twitter® is digital skill, forecasted volume is 80 and active is 10. All corresponding metrics are further used in the calculation.

According to some embodiments of the present disclosure, as the output, for the interval 5:00, as the forecasted interactions volume is high and adherence is low (<80) for the agent Tim, Mary, Ariel, the time-interval is marked as focus for them on their schedules. Similarly for digital skill Twitter® and interval 5.30 as count of forecasted volume and active count is high, four agents, e.g., Tim, Mary, Sheldon and Ariel with adherence <80% are having focus interval during this time-slot.

According to some embodiments of the present disclosure, in the provided data snapshot, there are three distinct skills: voice, chat, and Twitter®, each with their respective intervals. For example, in the voice skill at the 5:00 interval, there is a forecasted volume of 100 with zero active counts and a staffing requirement of 10 agents, each having an AHT of 10 seconds. The adherence data for agents, such as Tim, John, Mary, Sheldon, Pooja, and Ariel may be considered. Agents with lower adherence percentage, e.g., below a preconfigured threshold, like Tim and Ariel, have their focus intervals marked as ‘yes’ to ensure that they are scheduled to handle interactions during high-volume times to improve overall efficiency.

According to some embodiments of the present disclosure, similarly, in the chat skill at the 5:15 interval, the forecasted volume is 60 with 20 active counts and a staffing requirement of 5 agents, each with an AHT of 5 seconds. The adherence percentages of agents again determine whether a focus interval is necessary. In this case, only Ariel is marked with a focus interval due to consistently low adherence.

According to some embodiments of the present disclosure, for the Twitter® skill at the 5:30 interval, the forecasted volume is 80, with 10 active counts and a staffing requirement of 20 agents, each having an AHT of 8 seconds. Agents, such as Tim, Mary, Sheldon, and Ariel are marked with focus intervals to address the high interaction volume effectively.

According to some embodiments of the present disclosure, the conclusions drawn from this simulation indicate that intervals with high forecasted volumes and moderate AHT necessitate focus intervals for agents with low adherence to ensure coverage during critical times. Conversely, intervals with lower forecasted volumes and AHT do not require focus intervals. Additionally, for agents like Ariel Obama, who have consistently low adherence, all intervals are marked as focus intervals to ensure their availability and adherence improvement.

According to some embodiments of the present disclosure, this detailed analysis and automation of focus intervals, leveraging historical adherence data and real-time interaction forecasts, optimize workforce management by strategically allocating agents during high-demand periods. The flexibility in adjusting these intervals based on skill types and agent performance metrics ensures an efficient and responsive scheduling system that can adapt to varying operational needs.

FIG. 13 is a screenshot of a UI 1300 that is associated to a WFM system for manager to view schedule with focus time-slot, in accordance with some embodiments of the present disclosure.

According to some embodiments of the present disclosure, in a system, such as system 100A in FIG. 1A and such as system 100B in FIG. 1B, the schedule for various agents on Feb. 12, 2024, may be displayed via a UI, such as UI 1300. Each agent's schedule may be visually represented with distinct color codes. For example, gray may indicate periods where agents are scheduled to handle interactions, green may denote break durations, and blue may highlight focus intervals, e.g., focus-activity. These focus intervals, a unique feature of the system, are specifically designed to optimize agent performance based on historical adherence data and critical interval analysis.

According to some embodiments of the present disclosure, the schedule manager MS may provide a detailed overview of the workforce's allocation, enabling administrators to monitor and adjust schedules in real-time. By hovering over specific time-intervals, managers can view additional details, such as the focus interval for agent Abhijeet, which is from 7:00 AM to 7:15 AM. This time-interval may be identified as a critical period where high call volumes are expected, and agent Abhijeet's historical in-adherence data suggests optimal performance during this time. Conversely, agent Abhishek does not have a designated focus interval, e.g., focus-activity due to his past instances of high non-adherence, indicating areas for potential improvement in his scheduling or training.

According to some embodiments of the present disclosure, the UI 1300 may allow for dynamic adjustments. Managers can easily alter schedules, add or remove focus intervals, and address any deviations from planned adherence. This flexibility ensures that the workforce can adapt to changing demands and maintain high levels of efficiency. The snapshot also reveals the comprehensive list of agents, including their respective schedules and focus intervals, providing a holistic view of the team's readiness for the day.

According to some embodiments of the present disclosure, in the provided snapshot, agent Abhijeet's optimal focus interval is identified as 7:00 AM to 7:15 AM, based on his historical adherence data and critical interval analysis. Conversely, agent Abhishek does not have a designated focus interval due to his past instances of high non-adherence percentage. The system's ability to highlight these time-intervals allows managers to make informed decisions on workforce deployment, ensuring that high-volume periods are adequately staffed with agents who are likely to perform optimally.

According to some embodiments of the present disclosure, the UI 1300 may further enable a user to change the schedule as per the requirement or remove the focus interval, focus-activity altogether for the agent. This adaptability is crucial for maintaining operational efficiency and addressing any unforeseen changes in call volume or agent availability. The detailed visualization and interactive elements of the WFMs schedule manager may empower administrators to optimize their workforce management strategies effectively.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for determining critical-time-slots and scheduling focus-activity therefore during Workforce Management (WFM) scheduling, said computerized-method comprising:
while generating a schedule for agents in a database of agents for a period of time via a User Interface (UI) that is associated to a WFM system:
(i) retrieving forecast data of forecasted interaction volumes of traditional-interactions and forecasted active counts for digital-interactions for each time-slot in the period of time;
(ii) retrieving historic-data of adherence and calculating predicted out-of-adherence percentage based on in-adherence Key Performance Indicator (KPI) for each agent;
(iii) for each time-slot determining the time-slot as one of: traditional-interactions-time; and digital-interactions-time, based on the forecasted interaction volumes of traditional-interactions and the forecasted active counts for digital-interactions;
(iv) for each agent, for each time-slot that has been determined as traditional-interactions-time determining critical-traditional-interactions-time and for each time-slot that has been determined as digital-interactions-time, determining critical-digital-interactions-time based on the retrieved forecasted data, Average Handling Time (AHT) and maximum staffing; and
(v) for each agent having in-adherence above adherence-threshold, scheduling focus-activity for digital skills as the activity-type during time-slots that have been determined as critical-digital-interactions-time, and focus-activity for traditional skills as the activity-type during the time-slots that were determined as critical-traditional-interactions-time.

2. The computerized-method of claim 1, wherein the computerized-method further comprising scheduling activity-type that is not focus-activity during time-slots which were not determined as one of critical-traditional-interactions-time and critical-digital-interactions-time and scheduling activity-type that is not focus-activity during time-slots that the agent is not having in-adherence above adherence-threshold.

3. The computerized-method of claim 1, wherein the time-slot-is determined as traditional-interactions-time when the forecasted traditional-interactions volume is higher than the forecasted digital-interactions volume and wherein the time-slot is determined as digital-interactions-time when the forecasted digital-interactions volume is higher than the forecasted traditional-interactions volume.

4. The computerized-method of claim 1, wherein the time-slot is determined as critical-traditional-interactions-time, when a sum of maximum staffing, AHT and the forecasted interaction volumes of traditional-interactions during the time-slot is higher than a predefined threshold and wherein the time-slot is determined as critical-digital-interactions-time, when a sum of maximum staffing, AHT and the forecasted interaction volumes of digital-interactions during the time-slot is higher than the predefined threshold.

5. The computerized-method of claim 1, wherein the calculating of the predicted out-of-adherence percentage for each agent in the database of agents is according to formula I:
predicted out-of-adherence percentage=100−(Sum(in-adherence KPI)/Sum(time duration of each time-slot in the time-slots)*100, (I)
whereby,
the sum (adherence KPI) is the sum of the adherence KPI of the agent in all adherence-time-slots.

6. The computerized-method of claim 1, wherein said computerized-method further comprising publishing the schedule for each agent by pushing notifications via an application that is running on a computerized device of the agent.

7. The computerized-method of claim 1, wherein the activity-type of focus-activity indicates a time-slot that the agent has to be in-adherence.

8. The computerized-method of claim 1, wherein the scheduling is operated by a schedule manager Microservice (MS).

9. The computerized-method of claim 1, wherein the retrieving of the forecast data and historic-data of adherence for each agent is operated by using Representational State Transfer (REST) Application Programming Interfaces (API) s.

10. The computerized-method of claim 1, wherein the traditional-interactions are at least one of: voice-interactions and chat-interactions and wherein the digital-interactions are at least one of: social media chat messenger, email and messaging application.

11. The computerized-method of claim 1, wherein the generating of the schedule is operated by a user-click on an icon in the UI that is associated to the WFM system and wherein the schedule is displayed via the UI that is associated to the WFM system.

12. The computerized-method of claim 1, wherein the computerized-method further comprising configuring the WFM system to operate the generated schedule and to send an Automatic Call Distribution (ACD) application an update as to the activity-type for each agent when the activity-type has been scheduled as one of: focus-activity for digital skills and focus-activity for traditional skills, and wherein the computerized-method further comprising configuring the ACD application to automatically change a state of each agent that the activity-type has been scheduled as focus-activity for digital skills to ‘available’ during the time-slot, and to route digital interactions to agents with focus-activity for digital skills and traditional interactions to agents having focus-activity for traditional skills.

13. The computerized-method of claim 1, wherein the computerized-method further comprising configuring the WFM system to restrict any change of activity-type for agents during the time-slot that the activity-type is focus-activity for digital skills and during the time-slot that the activity-type is focus-activity for traditional skills.

14. The computerized-method of claim 13, wherein the change of activity-type is operated by one of: manually and coaching application.

15. The computerized-method of claim 1, wherein the computerized-method further comprising automatically sending a push notification for each agent via an application that is running on a computerized device of the agent at beginning and end of the time-slot that the activity-type is one of: focus-activity for digital skills and focus-activity for traditional skills.

16. A computerized-system for determining critical-time-slots and scheduling focus-activity therefore during Workforce Management (WFM) scheduling, said computerized-system comprising:
a database of agents;
a User Interface (UI) that is associated to a WFM system; and
one or more processors;
while generating a schedule for agents in the database of agents for a period of time via the User Interface (UI) that is associated to the WFM system:
(i) retrieving forecast data of forecasted interaction volumes of traditional-interactions and forecasted active counts for digital-interactions for each time-slot in the period of time;
(ii) retrieving historic-data of adherence and calculating predicted out-of-adherence percentage based on in-adherence Key Performance Indicator (KPI) for each agent;
(iii) for each time-slot determining the time-slot as one of: traditional-interactions-time; and
digital-interactions-time, based on the forecasted interaction volumes of traditional-interactions and the forecasted active counts for digital-interactions;
(iv) for each agent, for each time-slot that has been determined as traditional-interactions-time determining critical-traditional-interactions-time and for each time-slot that has been determined as digital-interactions-time, determining critical-digital-interactions-time based on the retrieved forecasted data, Average Handling Time (AHT) and maximum staffing; and
(v) for each agent having in-adherence above adherence-threshold, scheduling focus-activity for digital skills as the activity-type during time-slots that have been determined as critical-digital-interactions-time, and focus-activity for traditional skills as the activity-type during the time-slots that were determined as critical-traditional-interactions-time.
